(19) United States
(12) Patent Application Publication
(10) Pub. No.: US 2014/0016034 A1
(43) Pub. Date: Jan. 16, 2014

(54) HIGH DEFINITION VIDEO EXTENDER AND METHOD

(71) Applicant: Madalin Cirstea, East Lyme, CT (US)

(72) Inventor: Madalin Cirstea, East Lyme, CT (US)

(73) Assignee: VIDEO PRODUCTS, INC., Aurora, OH (US)

(21) Appl. No.: 13/549,565

(22) Filed: Jul. 16, 2012

(51) Int. Cl. H04N 7/00

(52) U.S. Cl. 348/460; 348/E07.001

(57) ABSTRACT

HDMI extenders based on HDBaseT technology are disclosed for extending HD signals from a video source to a display over a twisted pair cable. The extenders include local and remote units. The local unit receives HD signals from the video source; converts them into differential multimedia signals based on HDBaseT technology communicated over the cable to the remote unit which recovers the HD signals for the display. The local and remote units can also facilitate exchange of USB information, and/or digital or analog audio as differential common mode signals, and/or power as common mode signals along with the differential multimedia signals through the twisted pair cable. The remote unit can also receive IR commands, generate modulated signals preserving the IR carrier frequency of the commands; and transmit the modulated signals over the cable to the local unit for recovery of the IR commands to communicate to the video source.

### BACKGROUND AND SUMMARY

The present invention relates to an apparatus and method for transmitting high definition multimedia signals from a source to a display using a single cable medium having a plurality of conductors.

The digital visual interface (DVI) and the high definition multimedia interface (HDMI) are two common audiovisual standards for transmission of high definition video signals. DVI and HDMI define communication interfaces and protocols that are used to transport audio, video, and management information between audiovisual devices. The DVI or HDMI signals can be communicated via a single multimedia cable having isolated signals from an audiovisual device such as a DVD player, a cable box, etc. to another audiovisual device such as a television and/or display. HDMI and DVI interfaces use TMDS (Transition Minimized Differential Signaling) to send video data from a source to a display. Thus, the video data is generally compatible between the two standards, which means that an HDMI enabled television can display video from a DVI enabled source and vice versa. HDMI, however, additionally encodes digital audio data that cannot be extracted by a DVI display.

For purposes of this application, the remainder of the disclosure will focus primarily on the HDMI interface, but the scope of the claims includes DVI and HDMI signals, unless specifically excluded.

HDMI is a proprietary all-digital audio/video interface capable of transmitting uncompressed video streams. HDMI features generally include the capability to transmit billions of colors, variable high definition (HD) screen resolutions and high refresh rates for smooth motion sequences. HDMI also includes multi-channel digital compressed and uncompressed audio. The digital audio and video data transported using HDMI is transmitted electrically using a TMDS interface that is capable of sending high speed data with low noise. HDMI further includes device management control through two separate management buses: the consumer electronics control (CEC) bus and the display data channel (DDC) bus based on part of the inter-integrated circuit (I2C) bus. The primary medium used to transmit the HDMI information is copper wires that can drive the HDMI signals for a limited distance. HDMI devices are generally either sources of HDMI data or sinks of HDMI data. HDMI data is generally transferred from a source to a sink.

HDMI is compatible with the HDCP (High-bandwidth Digital Content Protection) digital rights management technology. HDMI provides an interface between any compatible digital audio/video source, such as a set-top box, a Blu-ray digital-versatile disc (DVD) player, an HD DVD player, a personal computer (PC), a video game console or an audio/video (AV) receiver and a compatible digital audio and/or video monitor, such as a digital television.

The HDMI interface was developed to transport high-speed digital video signals over relatively short distances using special HDMI cables. As the distance increases, the quality of the video degrades rapidly and the cost of the cable increases dramatically. Transmitting high-definition video over long distances without degrading the quality of the video signals is challenging, especially over a shielded or unshielded Ethernet cable, which is widely available and well accepted as a standard communication medium.

The main drawback of HDMI as an A/V connection standard, when it comes to high definition video distribution, is the cable length limitation. Installation costs quickly escalate when considering HDMI cables, control cables and HDMI repeaters for solving distance limitations. To cope with this limitation, a multitude of HDMI extender protocols over standard category 5e and 6 cables became available—each of these protocols providing a proprietary solution to support HDMI extension along with different control signals including CEC, infrared (IR), RS232, and universal serial bus (USB). The downside in all these implementations is that 150 feet proved to be the maximum distance for 1080p/24 bit/60 Hz resolution, with Full HD support guaranteed well under 100 feet. With growing popularity of 3D formats, the need for a new technology became apparent.

HDBaseT is a connectivity technology optimized for home and commercial multimedia distribution promoted by the HDBaseT Alliance. The HDBaseT technology includes a “5Play” feature, which can transmit full uncompressed high definition video, audio, 100BaseT Ethernet, power, and various control signals through a single standard 100 m/328 ft Category 5e, 6, 6a or 7 cable. HDBaseT also supports the HDCP digital rights management technology.

HDBaseT supports television and computer video formats including standard, enhanced, high-definition (HD) and three-dimensional (3D) video, and also supports many audio standards. HDBaseT supports 100 Mb Ethernet, enabling televisions, hi-fi equipment, computers and other devices to communicate with each other and to access stored multimedia content. Different types of control signals are also supported by HDBaseT technology.

An HDMI extender based on HDBaseT technology is disclosed for extending high definition (HD) multimedia signals from a HD video source to a display device over a single twisted pair cable having a plurality of twisted pair conductors. The HDMI extender includes a local unit and a remote unit, the remote unit being separate from the local unit. The local unit includes a video input port, a local port, local circuitry, a local USB hub, local USB circuitry and microcontrollers. The video input port receives local HD multimedia signals from the HD video source. The local HD multimedia signals include a plurality of video signals and at least one control signal. The local port is coupled to a first end of the twisted pair cable. The local circuitry is coupled to the video input port and to the local port. The local circuitry converts the local HD multimedia signals into a plurality of differential multimedia signals based on HDBaseT technology for communication through the local port over the twisted pair cable. The local USB hub couples to a local USB device. A primary microcontroller is coupled to the local USB hub, the local USB circuitry is coupled to the primary microcontroller, and a secondary microcontroller is coupled to the local USB hub and to the primary microcontroller. The remote unit includes a remote port, remote video circuitry, a remote video port, a remote USB hub and remote USB circuitry. The remote port is coupled to a second end of the twisted pair cable. The remote port receives the plurality of differential multimedia signals based on HDBaseT technology communicated from the local unit over the twisted pair cable. The remote video circuitry is coupled to the remote port, and the remote video circuitry converts the plurality of differential multimedia signals based on HDBaseT technology into remote HD multimedia signals. The remote video port is coupled to the remote video circuitry, and the remote video port provides the remote HD multimedia signals to the display device. The remote USB hub can be coupled to a plurality of remote USB devices. The remote USB circuitry is coupled to the remote USB hub. The local and remote USB circuitry facilitates bidirectional exchange of USB information as differential common mode USB signals along with the plurality of differential multimedia signals through the twisted pair cable. The local USB device communicates with the plurality of remote USB devices through the differential common mode USB signals. The differential common mode USB signals can be communicated over a first two pair of the plurality of twisted pair conductors of the twisted pair cable.

The local unit can also include digital and stereo audio inputs, a local audio codec and local audio circuitry, and the remote unit can also include digital and stereo audio outputs, a remote audio codec and remote audio circuitry. The digital audio input can receive a digital audio signal, and the stereo audio input can receive an analog audio input. The local audio codec can be coupled to the digital and stereo audio inputs, and the local audio codec can generate an audio output signal based on one of the digital and analog audio inputs. The local audio circuitry can be coupled to the local audio codec, and the local audio circuitry can convert the audio output signal into audio differential common mode signals for communication through the local port over the twisted pair cable. The remote audio circuitry can be coupled to the remote port, and the remote audio circuitry can recover the audio output signal from the audio differential common mode signals communicated from the local unit over the twisted pair cable. The remote audio codec can be coupled to the remote audio circuitry and to the digital and stereo audio outputs. The remote audio codec can convert the audio output signal into one of a digital audio output signal for output through the digital audio output, and an analog audio output signal for output through the stereo audio output. The audio differential common mode signals can be communicated over a second two pairs of the plurality of twisted pair conductors where the second two pairs are different from the first two pairs of the plurality of twisted pair conductors.

The HDMI extender can enable sharing of power between the local unit and the remote unit over the twisted pair cable using a DC voltage signal having a positive terminal and a ground terminal. The positive terminal can be coupled to a third two pairs of the plurality of twisted pair conductors, and the ground terminal can be coupled to a fourth two pairs of the plurality of twisted pair conductors, where the third two pairs are different from the fourth two pairs of the plurality of twisted pair conductors. The first two pairs of the plurality of twisted pair conductors can be the same as the fourth two pairs of the plurality of twisted pair conductors, and the second two pairs of the plurality of twisted pair conductors can be the same as the third two pairs of the plurality of twisted pair conductors.

The remote unit can also include an IR input port and remote IR circuitry, and local unit can also include an IR driver and an IR output port. The IR input port can receive IR commands from an IR receiver, where the IR commands have an IR carrier frequency. The remote IR circuitry can be coupled to the IR input port and to the remote video circuitry. The remote IR circuitry can generate a modulated signal preserving the IR carrier frequency of the received IR commands; and the remote video circuitry can transmit the modulated signal preserving the IR carrier frequency from the remote unit through the remote port over the twisted pair cable. The local circuitry can extract the modulated signal preserving the IR carrier frequency received through the local port over the twisted pair cable. The IR driver can be coupled to the local circuitry, and the IR driver can receive the modulated signal preserving the IR carrier frequency and generate IR commands based on the modulated signal. The IR output port can be coupled to the IR driver, and the IR output port can provide the IR commands to an IR transmitter for communicating to the HD video source.

When transmitting USB information from the local USB device to one of the plurality of remote USB devices, the following procedures can be implemented. The local USB circuitry can convert the USB information into the differential common mode USB signals comprising a positive voltage common mode USB signal component and a negative voltage common mode USB signal component, overlay the positive voltage common mode USB signal component onto a first differential multimedia signal of the plurality of differential multimedia signals on a first pair of the plurality of twisted pair conductors, overlay the negative voltage common mode USB signal component onto a second differential multimedia signal of the plurality of differential multimedia signals on a second pair of the plurality of twisted pair conductors, and transmit the positive and negative voltage common mode USB signal components through the local port over the first and second pairs of the plurality of twisted pair conductors. The remote USB circuitry can recover the USB information from the positive and negative voltage common mode USB signal components received through the remote port on the first and second pairs of the plurality of twisted pair conductors, and communicate the USB information to one of the plurality of remote USB devices.

When transmitting USB information from one of the plurality of remote USB devices to the local USB device, the following procedures can be implemented. The remote USB circuitry can convert the USB information into the differential common mode USB signals comprising the positive and negative voltage common mode USB signal components, overlay the positive voltage common mode USB signal component onto the first pair of the plurality of twisted pair conductors, overlay the negative voltage common mode USB signal component onto the second pair of the plurality of twisted pair conductors, and transmit the positive and negative voltage common mode USB signal components through the remote port over the first and second pairs of the plurality of twisted pair conductors. The local USB circuitry can recover the USB information from the positive and negative voltage common mode USB signal components received through the local port on the first and second pairs of the plurality of twisted pair conductors, and communicate the USB information to the local USB device.

The secondary microcontroller can be coupled to the local USB circuitry through the primary microcontroller, and the local USB device can communicate with a first remote USB device of the plurality of remote USB devices through the primary microcontroller, and the local USB device can communicate with a second remote USB device of the plurality of remote USB devices through the secondary microcontroller and the primary microcontroller. The first USB device can be one of a USB touch screen monitor, a USB CAC card reader and a USB whiteboard. The second USB device can be a USB keyboard or mouse.

Another embodiment of an HDMI extender is disclosed for extending high definition (HD) multimedia signals from a HD video source to a display device over a single twisted pair cable having a plurality of twisted pair conductors. The HDMI extender includes a local unit and a separate remote unit. The local unit includes a video input port, a local port, local circuitry, digital and stereo audio inputs, a local audio codec and local audio circuitry. The video input port receives local HD multimedia signals from the HD video source where the local HD multimedia signals include a plurality of video signals and at least one control signal. The local port is coupled to a first end of the twisted pair cable. The local circuitry is coupled to the video input port and to the local port. The local circuitry converts the local HD multimedia signals into a plurality of differential multimedia signals for communication through the local port over the twisted pair cable. The digital audio input can receive a digital audio signal, and the stereo audio input can receive an analog audio input. The local audio codec is coupled to the digital and stereo audio inputs, and the local audio codec can generate an audio output signal based on one of the digital and analog audio inputs. The local audio circuitry is coupled to the local audio codec, and the local audio circuitry converts the audio output signal into audio differential common mode signals for communication through the local port over the twisted pair cable. The remote unit includes a remote port, remote video circuitry, a remote video port, remote audio circuitry, digital and stereo audio outputs, and a remote audio codec. The remote port is coupled to a second end of the twisted pair cable. The remote port receives the plurality of differential multimedia signals and the audio differential common mode signals communicated from the local unit over the twisted pair cable. The remote video circuitry is coupled to the remote port, and the remote video circuitry converts the plurality of differential multimedia signals into remote HD multimedia signals. The remote video port is coupled to the remote video circuitry, and the remote video port provides the remote HD multimedia signals to the display device. The remote audio circuitry is coupled to the remote port, and the remote audio circuitry recovers the audio output signal from the audio differential common mode signals. The remote audio codec is coupled to the remote audio circuitry and to the digital and stereo audio outputs. The remote audio codec converts the audio output signal into one of a digital audio output signal for output through the digital audio output, and an analog audio output signal for output through the stereo audio output. The audio differential common mode signals can be communicated over two pair of the plurality of twisted pair conductors of the twisted pair cable.

The local audio circuitry can convert the audio output signal into the audio differential common mode signals comprising a positive voltage common mode audio signal component and a negative voltage common mode audio signal component, overlay the positive voltage common mode audio signal component onto a third differential multimedia signal of the plurality of differential multimedia signals on a third pair of the plurality of twisted pair conductors, overlay the negative voltage common mode audio signal component onto a fourth differential multimedia signal of the plurality of differential multimedia signals on a fourth pair of the plurality of twisted pair conductors, and transmit the positive and negative voltage common mode audio signal components through the local port over the third and fourth pairs of the plurality of twisted pair conductors, and the remote audio circuitry can recover the audio output signal from the positive and negative voltage common mode audio signal components received through the remote port on the third and fourth pairs of the plurality of twisted pair conductors, and communicate the audio output signal to one of the digital and stereo audio outputs.

In certain embodiments, the digital audio input can receive an SPDIF audio signal and the digital audio output can output the SPDIF audio signal. When the local audio codec senses an SPDIF audio signal, the local audio codec can generate the audio output signal including a PLL lock signal based on the SPDIF audio signal; the remote audio circuitry can recover the audio output signal; and the remote audio codec can output the SPDIF audio signal based on the audio output signal for output through the digital audio output.

Another HDMI extender based on HDBaseT technology is disclosed for extending high definition (HD) multimedia signals from a HD video source to a display device over a single twisted pair cable having a plurality of twisted pair conductors. The HDMI extender comprises a local unit and a separate remote unit. The local unit includes a video input port, a local port, local circuitry,

a video input port for receiving local HD multimedia signals from the HD video source, the local HD multimedia signals including a plurality of video signals and at least one control signal; an IR driver and an IR output port. The local port is coupled to a first end of the twisted pair cable. The local circuitry is coupled to the video input port and to the local port. The local circuitry converts the local HD multimedia signals into a plurality of differential multimedia signals for communication through the local port over the twisted pair cable and extracts a modulated signal preserving an IR carrier frequency received through the local port over the twisted pair cable. The IR driver is coupled to the local circuitry, and the IR driver receives the modulated signal preserving the IR carrier frequency and generates IR commands based on the modulated signal. The IR output port is coupled to the IR driver, and the IR output port provides the IR commands to an IR transmitter for communicating to the HD video source. The remote unit includes a remote port, an IR input port, remote IR circuitry, remote video circuitry and a remote video port. The remote port is coupled to a second end of the twisted pair cable, and the remote port receives the plurality of differential multimedia signals communicated from the local unit over the twisted pair cable. The IR input port receives IR commands from an IR receiver. The remote IR circuitry is coupled to the IR input port, and the remote IR circuitry generates the modulated signal preserving the IR carrier frequency of the received IR commands. The remote video circuitry is coupled to the remote IR circuitry and to the remote port. The remote video circuitry converts the plurality of differential multimedia signals into remote HD multimedia signals and transmits the modulated signal preserving the IR carrier frequency from the remote unit through the remote port over the twisted pair cable. The remote video port is coupled to the remote video circuitry, and the remote video port provides the remote HD multimedia signals to the display device. The remote IR circuitry can include an IR carrier reshaping circuit that generates a pulse each carrier cycle, measures cycle duration, and changes polarity of the modulated signal at half the measured cycle duration.

Another embodiment of an HDMI extender based on HDBaseT technology is disclosed for extending high definition (HD) multimedia signals from a HD video source to a display device over a single twisted pair cable having a plurality of twisted pair conductors. The HDMI extender includes a local unit and a separate remote unit. The local unit includes a video input port, a local port and local circuitry. The video input port receives local HD multimedia signals from the HD video source, where the local HD multimedia signals include a plurality of video signals and at least one control signal. The local port is coupled to a first end of the twisted pair cable. The local circuitry converts the HD multimedia signals into a plurality of differential multimedia signals for communication through the local port over the twisted pair cable, and shares power over the twisted pair cable as a common mode power signal. The remote unit includes a remote port, remote circuitry and a remote video port. The remote port is coupled to a second end of the twisted pair cable, and the remote port receives the plurality of differential multimedia signals output from the local unit. The remote circuitry is coupled to the remote port, and the remote circuitry converts the plurality of differential multimedia signals into remote HD multimedia signals and shares the power over the twisted pair cable as the common mode power signal. The remote video port is coupled to the remote circuitry, and the remote video port provides the remote HD multimedia signals to the display device. The power shared between the local unit the remote unit over the twisted pair cable can be a DC voltage signal having a positive terminal and a ground terminal, where the positive terminal is coupled to two pairs of the plurality of twisted pair conductors, and the ground terminal is coupled to a different two pairs of the plurality of twisted pair conductors. The DC voltage signal can be 24 V. The power source providing the power can be coupled to one of the local unit and the remote unit, and supply power to both the local unit and the remote unit.

### BRIEF DESCRIPTION OF THE DRAWINGS

FIG. 1 is an exemplary illustration of a system for extending high definition multimedia signals between a signal source coupled to a local unit and a signal sink coupled to a remote unit;

FIG. 2 is a schematic block diagram illustrating an exemplary local unit;

FIG. 3 is a schematic block diagram illustrating the use of common mode voltage to exchange information between the local unit and the remote unit; and

FIG. 4 is a schematic block diagram illustrating an exemplary remote unit.

### DESCRIPTION OF EXEMPLARY EMBODIMENTS

The exemplary embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

HDBaseT technology can be incorporated into HDMI signal extenders. An exemplary embodiment of an HDMI extender can support full HD/3D extension to 328 feet, with support for HDCP, CEC, IR and SPDIF (Sony Philips Digital Interconnect Format). Another exemplary embodiment of an HDMI extender can support these features plus 100BaseT Ethernet, RS232, and USB support for USB keyboard/mouse and an additional USB device, such as a USB touch screen monitor, USB CAC card reader or USB whiteboard. Other exemplary embodiments can support other combinations of features. These extenders can be designed to require only one power supply to power both the local and remote units, and the power supply can be attached at either end of the extender.

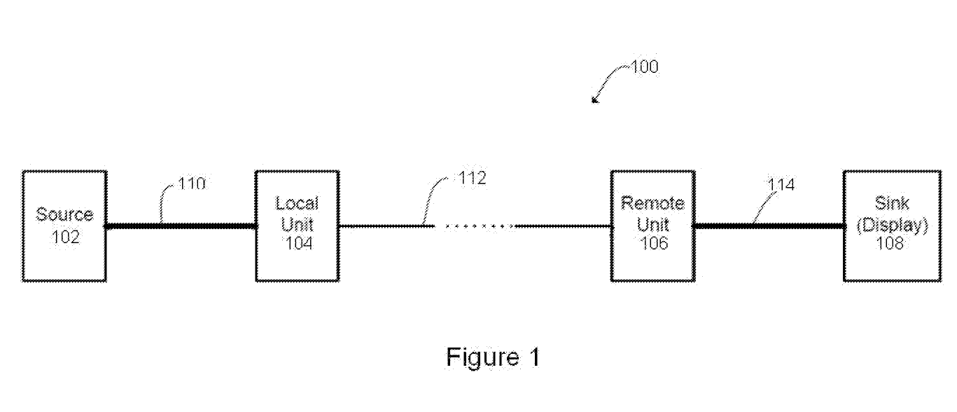

FIG. 1 illustrates an exemplary system 100 that includes a source of high definition video signals 102, a local unit 104, a remote unit 106 and a display 108. The source 102 is coupled to the local unit 104 by an HDMI/DVI cable 110. The local unit 104 is coupled to the remote unit 106 by an appropriate cable 112, for example a category 5e, 6, 6a or 7 cable. The remote unit 106 is coupled to the sink 108 by a HDMI/DVI cable 114. The distance between the local unit 104 and the remote unit 106 may be any desired distance, typically up to 328 feet. One of ordinary skill in the art will readily appreciate that the distance between the local unit 104 and remote unit 106 is provided for illustrative purposes and not intended to limit the scope of the present invention.

The source 102 may be any suitable source of high definition multimedia signals. For example, the source 102 may be a DVD player, HD DVD player, Blu-ray DVD player, a cable TV set-top box, a satellite TV set-top box, a computer, etc. The source of high definition multimedia signals 102 may output HDMI and/or DVI compliant signals. Generally, the source 102 will output high definition multimedia signals in the form of four differential signals (three digital video signals and one clock signal).

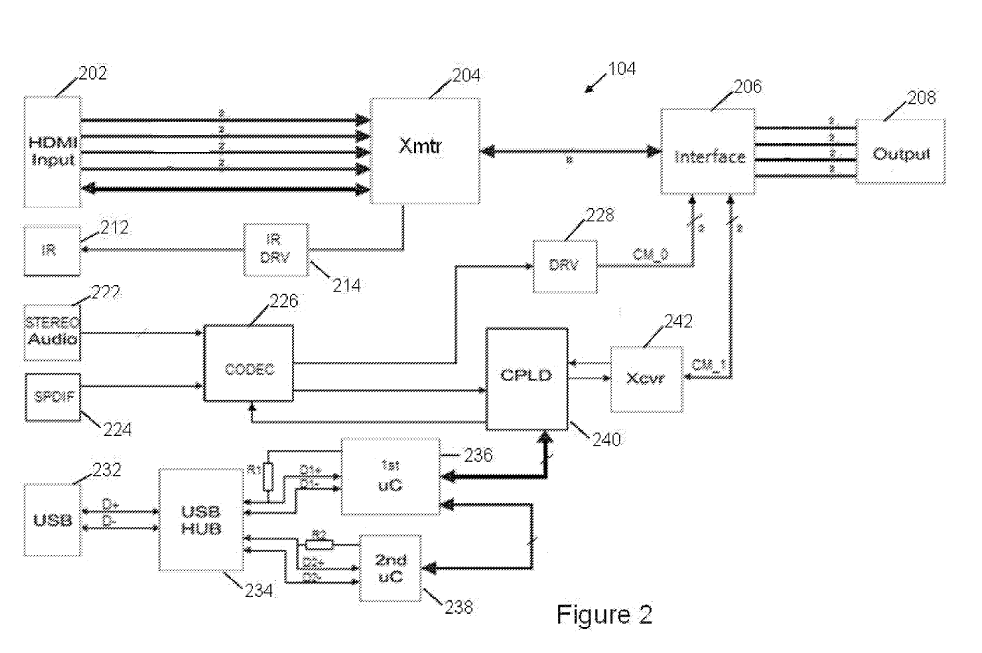

FIG. 2 is a block diagram of an exemplary local unit 104. The local unit 104 includes a video input port 202, an HDBaseT transmitter chip 204, a local interface 206 and a local port 208. The local unit 104 also includes an infrared (IR) output port 212, a stereo audio input port 222, an SPDIF input port 224, and a bi-directional USB port 232. The local interface 206 and the local port 208 can be configured for an RJ-45 connector.

The video input port 202 receives the high definition video and accompanying signals from the source 102 which includes four transition minimized differential signals (TMDS), which are commonly referred to as D0, D1, D2, DCLK. The D0, D1 and D2 signals contain data related to video signals and the DCLK signal is a clock signal. The video input port 202 also includes a bi-directional bus for communicating a display data channel (DDC) signal, a consumer electronic control bus (CEC) signal, a hot-plug signal and a +5V signal with the source 102. The DDC signals can be used by an HDMI source to discover the configuration and/or capabilities of an HDMI sink. The CEC bus provides high-level control functions between HDMI devices. For example, the CEC bus can enable a single remote control module to control multiple HDMI devices within a CEC bus chain. The +5V signal can be used to indicate to the sink 108 that a source 102 is connected and powered on. The hot-plug signal can be used to indicate to the source 102 that the sink 108 is powered on and connected to the remote unit 106 providing that local unit 104 and remote unit 106 are connected via cable 112 and powered on.

The signals received at the video input port 202 from the source 102 are routed to the HDBaseT transmitter 204. An exemplary HDBaseT transmitter is the Valens VS100TX HDBaseT Transmitter, which is manufactured by Valens Semiconductor Ltd. of Hod Hasharon, Israel. The HDBaseT transmitter 204 processes the input signals from the source 102 and outputs an HDBaseT signal to the local interface 206 which adds common mode signals as described below for output through the local port 208. The HDBaseT signal with the added common mode signals at the local port 208 comprises four signals: D_OUT0, D_OUT1, D_OUT2, D_OUT3.

An IR control signal received by the HDBaseT transmitter 204 from the remote unit 106 through the local interface 206 can be routed to an IR driver 214. There is no need for a modulator at this point because an IR carrier can be sent as opposed to a demodulated IR signal. The IR carrier signal can be embedded into the HDBaseT signals and sent transparently from the remote unit 106 to the local unit 104. An IR transmitter (e.g., IR LED) connected to the IR output port 212 can transmit the IR control signal with the carrier signal to the source 102.

The USB port 232 is coupled to a USB hub 234 which is coupled to a primary microcontroller 236 and a secondary microcontroller 238. The two microcontrollers can be used to support two different classes of USB devices. For example, the primary microcontroller 236 can present itself as a USB touch screen, USB CAC card reader or USB whiteboard; while the secondary microcontroller 238 can identify itself as a USB keyboard and mouse. Each microcontroller controls the 1.5 KOhm pull up resistor R1, R2 respectively, used to signal the computer when a USB device is connected or disconnected. The primary microcontroller 236 can wait for the descriptor of the attached device to be transmitted by the remote unit 106. For example, the device can be a USB touch screen monitor, USB CAC card reader or USB whiteboard or other type of USB device. Once the identification of the device is made and the primary microcontroller 236 receives the descriptor, then it can switch the resistor R1 to 3.3V to signal the computer that the device is attached. The secondary microcontroller 238 does not have to wait for the descriptors from the remote unit 106. It can switch the pull up resistor R2 to 3.3V right away and present itself as a generic keyboard and mouse. The primary microcontroller 236 is coupled to a controller 240 to facilitate the exchange of USB data between the local unit 104 and the remote unit 106. The primary microcontroller 236 can extract the data packets assigned to the secondary microcontroller 238 and send them via an I2C interface to the secondary microcontroller 238. The primary microcontroller 236 can also read the USB commands coming from the secondary microcontroller 238 and write them to the controller 240 to be sent to the remote unit 106. An exemplary primary microcontroller is LPC2366 manufactured by NXP Semiconductor, and an exemplary secondary microcontroller is CY7C64215 manufactured by Cypress Semiconductor.

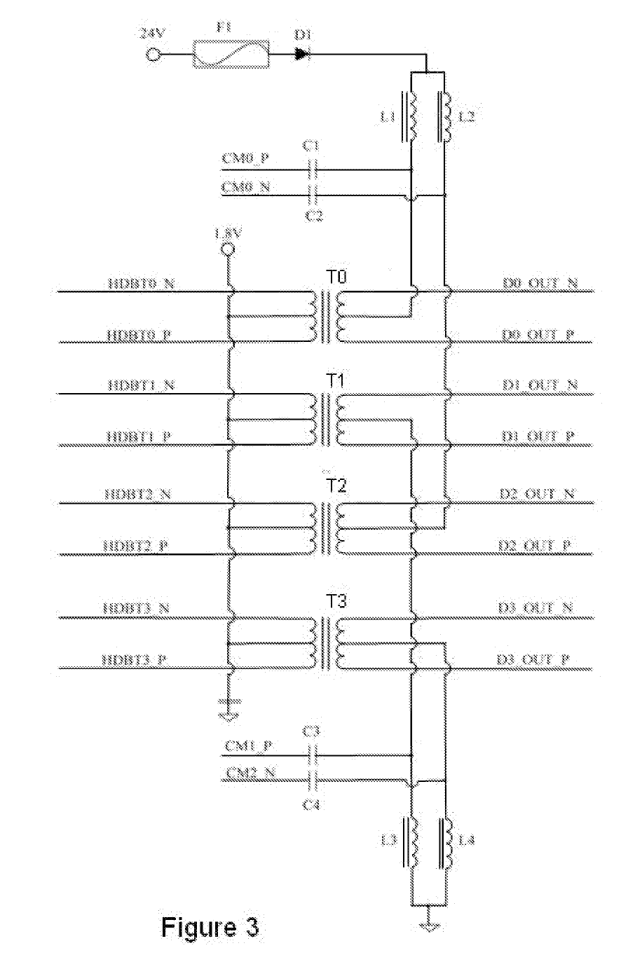

The controller 240 may be any type of controller suitable for high speed processing of high quality signals. For example, the controller 240 may be a complex programmable logic device (CPLD), ASIC, field programmable gate array, CPU, microcontroller, microprocessor or the like. The controller 240 can implement the physical layer of the protocol between the local unit 104 and the remote unit 106. The controller 240 is coupled to the local interface 206 through a transceiver 242 which can be a half duplex RS485 transceiver. The control signals as well as USB commands are turned into differential signals and applied as common mode voltages CM1_P and CM1_N to pairs D1_OUT and D3_OUT as depicted in FIG. 3. In receiving mode, the control signals and USB data packets are transformed to single ended signals and applied to the input of the controller 240. An exemplary controller 240 is XC9572 manufactured by Xilinx.

Support for stereo audio allows the user to extend audio from a DVI source to a DVI or HDMI display. Analog stereo audio signals (left, right) may be received by the local unit 104 from an analog stereo audio source (not shown) at the stereo audio port 222. Digital audio signals may be received by the local unit 104 from a digital audio source (not shown) at the SPDIF port 224. The analog or digital audio signals received at the stereo audio port 222 and the SPDIF port 224 are routed to an audio encoder/decoder (codec) 226. The audio codec 226 can generate a phase-locked loop (PLL) lock signal when a valid SPDIF signal is present at its input. This PLL lock signal can be used to control the input to be transmitted to the remote unit 106; for example an SPDIF input when the lock signal is active and a stereo audio input when the lock signal is inactive. The audio codec 226 outputs an audio signal that is generated either from the SPDIF input 224 or the stereo audio input 222, according to the mode selected. The audio output signal is routed to a driver 228 which converts the single-ended audio signal into differential signals that are routed to the local interface 206 for output as common mode voltages CM0_P and CM0_N over the channel formed by output pair D0_OUT and D2_OUT. An exemplary stereo audio codec is the NXP UDA1355H Codec, which is manufactured by NXP Semiconductor N.V. of Eindhoven, Netherlands.

FIG. 3 illustrates an exemplary RJ-45 interface and the use of common mode voltages to transmit digital audio and control signals in packet form. FIG. 3 illustrates the components of a local RJ45 interface 206 that combines signals into common mode signals. The HDBaseT input signals (HDBT0, HDBT1, HDBT2, HDBT3) from the HDBaseT transmitter 204 are illustrated on the left side from top to bottom respectively. The HDBaseT output signals with added common mode signals (D0_OUT, D1_OUT, D2_OUT, D3_OUT) output to the local port 208 are illustrated on the right side from top to bottom respectively. The four HDBaseT input signals, HDBT0-3, can be coupled to the four HDBaseT output signals, D0_OUT-D3_OUT, respectively, across four transformers T0-3 as shown in FIG. 3. The HDBaseT signals themselves are not modified since the differential signals on the right side are identical to the differential signals on the left side. However, the common mode signals and power are added on the right side of the transformers T0-3.

A DC signal is split between a tap on the output side of transformer T0 and a tap on the output side of transformer T2 and a first common mode differential signal CM0 from the driver 228 carrying the audio output signal is overlaid thereon, with the CM0_P signal being overlaid on the tap on the output side of transformer T0, and the CM0_N signal being overlaid on the tap on the output side of transformer T2. Common mode signals CM0_P and CM0_N are injected via the capacitors C1, C2. The inductors L1, L2 act as chokes to isolate the common mode signal from the DC voltage. Thus, the first common mode signal CM0 from the driver 228 carrying the audio output signal is a differential signal between the common mode voltages of output signals D0_OUT and D2_OUT. The embodiment shown in FIG. 3 shows a 24V DC signal but one of ordinary skill in the art will readily appreciate that this value is exemplary in nature and other voltages can be used within the scope of the present invention.

A tap on the output side of transformer T1 and a tap on the output side of transformer T3 are coupled to ground and a second common mode differential signal CM1 from the transceiver 242 carrying the control signals is overlaid thereon, with the CM1_P signal being overlaid on the tap on the output side of transformer T1, and the CM1_N signal being overlaid on the tap on the output side of transformer T3. Common mode signals CM1_P and CM1_N are injected via the capacitors C3, C4. The inductors L3, L4 act as chokes to isolate the common mode signal from the ground. Thus, the second common mode differential signal CM1 from the transceiver 242 carrying the control signals and USB commands and data is a differential signal between the common mode voltages of output signals D1_OUT and D3_OUT.

The remote unit 106 includes substantially the same circuitry as illustrated in FIG. 3, a discussion of which will be omitted for the sake of brevity.

The HDBaseT technology supports power over cable similar to Power over Ethernet (PoE). It defines a power source equipment (PSE) and a powered device (PD). The PSE is usually powered with a DC voltage between 50 to 57V. This relatively high DC voltage requires additional safety precautions for DC isolation, and more complex protections. These additional safety requirements can be avoided by applying 24V DC power directly to the four output pairs as represented in FIG. 3. Only one 24V power supply is necessary and it can be attached to either the local unit 104 or the remote unit 106 and both units can receive power from the same source. The output signals of the local interface 206 can provide power over the RJ-45 twisted pair cable medium. The power is applied to the D0_OUT and D2_OUT signal pairs and GND is applied to the D1_OUT and D3_OUT signal pairs.

The signals from the local unit 104 are output through the local port 208 and are transmitted across a cable medium to a remote port 408 of the remote unit 106. The cable medium is coupled at the local port 208 through an appropriate connector that is connected to the cable medium, and is coupled at the remote port 408 through an appropriate connector that is connected to the cable medium. A suitable connector may be an RJ45 connector. The signals output from the local port 208 include four pairs of differential signals. The signals can be transmitted using Ethernet CAT5e, CAT6 cable or similar cables that contain at least 4 twisted pairs of conductors. Although disclosed as having RJ45 connectors, one of ordinary skill in the art will appreciate other suitable connectors may be used in accordance with aspects of the present invention. Signals that have been converted to serial data signals are re-constructed at the remote unit 106 for use by the sink 108.

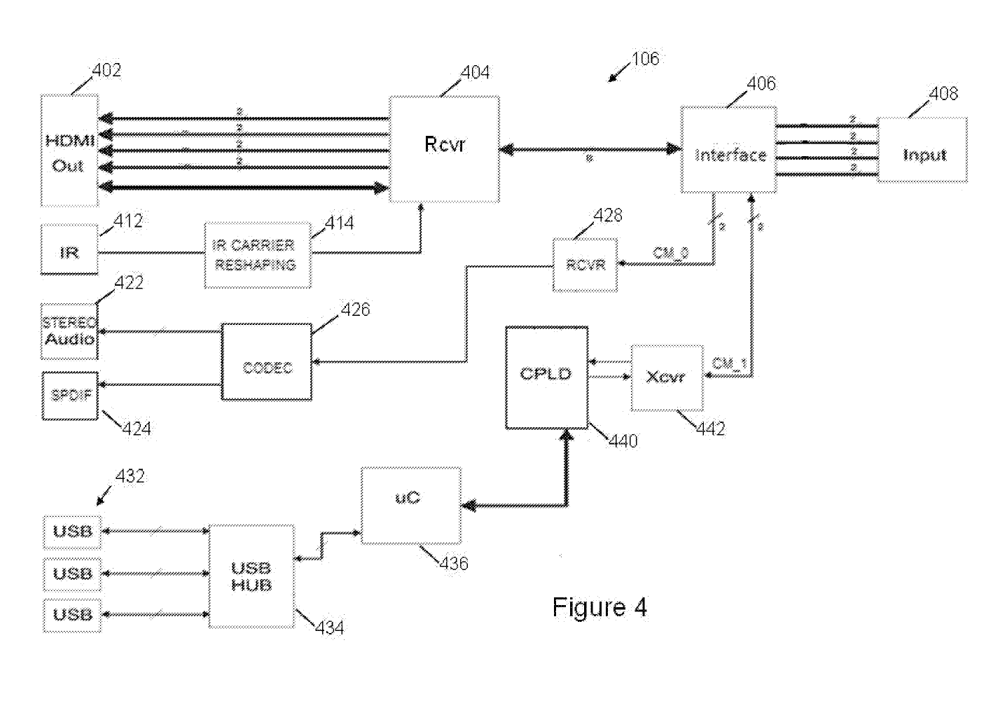

FIG. 4 is a block diagram of an exemplary remote unit 106. The remote unit 106 includes a remote port 408, a remote interface 406, an HDBaseT receiver chip 404 and a video output port 402. The signal from the remote unit 106 to the sink 108 is sent through the video output port 402. The remote unit 106 also includes an IR input port 412, a stereo audio output port 422, an SPDIF output port 424 and one or more bi-directional USB ports 432. The remote interface 406 and the remote port 408 can be configured for an RJ-45 connector.

The remote port 408 receives the HDBaseT signal with the added common mode signals from the local port 208 of the local unit 104, and routes it to the remote interface 406. The remote interface 406 may be an Ethernet transformer that removes DC bias associated with the received signals. The remote interface 406 passes the received HDBaseT signal to the HDBaseT receiver chip 404, routes the first differential common mode signal CM0 from the received HDBaseT signals D0_OUT and D2_OUT to a receiver 428, and routes the second differential common mode signal CM1 from the received HDBaseT signals D1_OUT and D3_OUT to a transceiver 442

The HDBaseT receiver chip 404 converts the HDBaseT input into an HDMI output signal for output. The output of the HDBaseT receiver chip 404 are high speed differential video signals (e.g., D0, D1, D2 and DCLK, as discussed above) for output through the video output port 402 and input to the sink 108 (FIG. 1). It is typically desirable to recreate the signals output by the HDBaseT receiver chip 404 to correspond as close as possible to the signals received at the local unit 104 from the source 102. An exemplary HDBaseT receiver is the Valens VS100RX HDBaseT Receiver, which is manufactured by Valens Semiconductor Ltd. of Hod Hasharon, Israel.

The common mode control signals transmitted through the remote interface 406 are coupled to the transceiver 442. As shown in FIG. 4, the transceiver 442 transforms the control signals and USB commands received on common mode channel CM1 from differential to single ended form to be transmitted to a remote controller 440. The remote controller 440 may be the same type of controller as the local controller 240, discussed above. The remote controller 440 routes the control signals and the USB commands to a remote microcontroller 436. The transceiver 442 can also receive control signals and USB data packets from microcontroller 436 to be sent to local unit 104. In transmit mode, the transceiver 442 receives the control signals and USB data packets from the controller 440 and transforms the signals from single ended to differential form to be applied to common mode channel CM1 for output to the local unit 104 through the remote interface 406.

The microcontroller 436 is coupled to a USB hub 434 for communication through USB ports 432 with attached USB devices. Various USB devices can be attached, for example USB keyboard, USB mouse and other devices that can be for example a USB touch screen monitor, USB CAC card reader or USB whiteboard. The microcontroller 436 implements a USB host controller, and will do a complete enumeration of USB keyboard and USB mouse. In the case of a device of the type mentioned above, the microcontroller 436 can start enumeration by reading the descriptor from the device, and then send the descriptor to the local unit 104 that will provide it to the computer. After that, the enumeration phase will be finalized by the computer.

The common mode audio signal CM0 transmitted through the remote interface 406 is transformed to a single ended signal at the receiver 428 and input to the remote audio codec 426. The remote audio codec 426 can be the same type of audio codec as the local audio codec 226, discussed above. The remote audio codec 426 decodes the audio signal from the receiver 428 and outputs stereo audio or digital SPDIF audio signals through the stereo audio output 422 or the SPDIF audio output 424.

Since the display 108 may be up to 328 feet away from the source 102, it is desirable to have an infrared receiver coupled to the IR input port 412 of the remote unit 106 in order to allow the user to control the source 102 while present at or near the sink 108 (e.g., a display). Therefore, the local unit 104 and the remote unit 106 are also operable to exchange infrared signals. Accordingly, the remote unit 106 may have an IR receiver coupled to the IR input port 412 to receive control signals to be routed through the remote port 408 to the local unit 104 and transmitted to the source 102 in order to control one or more functions of the source 102.

The IR extension recommended by the HDBaseT technology uses an IR receiver at the remote unit 106 that outputs a demodulated IR signal. This method requires having a type of modulator at the local unit 104 that reconstructs the IR signal and applies it to an IR emitting diode. The disadvantage of this solution is that it cannot support a large variety of remote controls as the modulation frequency can be anywhere between 30 and 60 KHz. Infrared receivers are usually very selective. An alternative shown in FIG. 4 is to use an IR receiver coupled to the IR port 412 in the remote unit 106 that is typically used in IR repeaters that outputs the modulated signal, hence preserving the original carrier frequency. Many IR receivers of this type will not output a 50% duty cycle carrier when the frequency is close to its maximum supported value. An IR carrier reshaping circuit 414, which can be implemented in CPLD, can be used to compensate for this. The carrier reshaping circuit 414 can generate a pulse each carrier cycle and control a counter that measures the duration of a cycle. The value of the counter can then be loaded into a register and the next cycle the output signal can change polarity at exactly half period appearing as a 50% duty cycle signal. The reshaped carrier can then be sent on the same IR channel recommended by the HDBaseT technology. The sampling frequency of this signal is at 500 KHz according to Valens Semiconductor, so a successful signal reconstruction can be performed at the local unit 104.

For end-user ease of use, an IR receiver coupled to the IR port 412 can be mounted on the edge of the sink device 108 with the window of the IR receiver facing the user (the same direction as the display screen). An IR transmitter coupled to the IR output port 212 can be positioned such that the IR transmitter is in the line of sight of an IR window of the source 102.

Although aspects of the invention have been described in the context of hardware circuitry, as used herein the term “circuitry” can mean hardware and/or software to perform a claimed function.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains.

I claim:

1. An HDMI extender for extending high definition (HD) multimedia signals from a HD video source to a display device over a single twisted pair cable having a plurality of twisted pair conductors, the HDMI extender comprising:
a local unit comprising:
a video input port receiving local HD multimedia signals from the HD video source, the local HD multimedia signals including a plurality of video signals and at least one control signal;
a local port coupled to a first end of the twisted pair cable;
local circuitry coupled to the video input port and to the local port, the local circuitry converting the local HD multimedia signals into a plurality of differential multimedia signals based on HDBaseT technology for communication through the local port over the twisted pair cable;
a local universal serial bus (USB) hub for coupling to a local USB device;
a primary microcontroller coupled to the local USB hub;
local USB circuitry coupled to the primary microcontroller;
a secondary microcontroller coupled to the local USB hub and to the primary microcontroller;
a remote unit separate from the local unit, the remote unit comprising:
a remote port coupled to a second end of the twisted pair cable, the remote port receiving the plurality of differential multimedia signals communicated from the local unit over the twisted pair cable;
remote video circuitry coupled to the remote port, the remote video circuitry converting the plurality of differential multimedia signals based on HDBaseT technology into remote HD multimedia signals;
a remote video port coupled to the remote video circuitry, the remote video port providing the remote HD multimedia signals to the display device;
a remote USB hub for coupling to a plurality of remote USB devices;
remote USB circuitry coupled to the remote USB hub, the local and remote USB circuitry facilitating bidirectional exchange of USB information as differential common mode USB signals along with the plurality of differential multimedia signals through the twisted pair cable;
wherein the local USB device communicates with the plurality of remote USB devices through the differential common mode USB signals.

2. The HDMI extender of claim 1, wherein the differential common mode USB signals are communicated over a first two pair of the plurality of twisted pair conductors of the twisted pair cable.

3. The HDMI extender of claim 2, wherein the local unit further comprises:
a digital audio input for receiving a digital audio signal;
a stereo audio input for receiving an analog audio input;
a local audio codec coupled to the digital and stereo audio inputs, the local audio codec generating an audio output signal based on one of the digital and analog audio inputs;
local audio circuitry coupled to the local audio codec, the local audio circuitry converting the audio output signal into audio differential common mode signals for communication through the local port over the twisted pair cable;
the remote unit further comprises:
remote audio circuitry coupled to the remote port, the remote audio circuitry recovering the audio output signal from the audio differential common mode signals communicated from the local unit over the twisted pair cable;
a digital audio output;
a stereo audio output; and
a remote audio codec coupled to the remote audio circuitry and to the digital and stereo audio outputs, the remote audio codec converting the audio output signal into one of a digital audio output signal for output through the digital audio output, and an analog audio output signal for output through the stereo audio output;
wherein the audio differential common mode signals are communicated over a second two pairs of the plurality of twisted pair conductors of the twisted pair cable, the second two pairs being different from the first two pairs of the plurality of twisted pair conductors.

4. The HDMI extender of claim 3, wherein power is shared between the local unit and the remote unit over the twisted pair cable using a DC voltage signal having a positive terminal and a ground terminal, the positive terminal being coupled to a third two pairs of the plurality of twisted pair conductors, and the ground terminal being coupled to a fourth two pairs of the plurality of twisted pair conductors, the third two pairs being different from the fourth two pairs of the plurality of twisted pair conductors.

5. The HDMI extender of claim 4, wherein the first two pairs of the plurality of twisted pair conductors is the same as the fourth two pairs of the plurality of twisted pair conductors, and the second two pairs of the plurality of twisted pair conductors is the same as the third two pairs of the plurality of twisted pair conductors.

6. The HDMI extender of claim 5, wherein the remote unit further comprises:
an IR input port for receiving IR commands from an IR receiver, the IR commands having an IR carrier frequency;
remote IR circuitry coupled to the IR input port, the remote IR circuitry generating a modulated signal preserving the IR carrier frequency of the received IR commands; the remote video circuitry being coupled to the remote IR circuitry, the remote video circuitry transmitting the modulated signal preserving the IR carrier frequency from the remote unit through the remote port over the twisted pair cable;
the local unit further comprises:
an IR driver coupled to the local circuitry, the local circuitry extracting the modulated signal preserving the IR carrier frequency received through the local port over the twisted pair cable; the IR driver receiving the modulated signal preserving the IR carrier frequency and generating IR commands based on the modulated signal; and
an IR output port coupled to the IR driver, the IR output port providing the IR commands to an IR transmitter for communicating to the HD video source.

7. The HDMI extender of claim 2, wherein when transmitting USB information from the local USB device to one of the plurality of remote USB devices,
the local USB circuitry converts the USB information into the differential common mode USB signals comprising a positive voltage common mode USB signal component and a negative voltage common mode USB signal component, overlays the positive voltage common mode USB signal component onto a first differential multimedia signal of the plurality of differential multimedia signals on a first pair of the plurality of twisted pair conductors, overlays the negative voltage common mode USB signal component onto a second differential multimedia signal of the plurality of differential multimedia signals on a second pair of the plurality of twisted pair conductors, and transmits the positive and negative voltage common mode USB signal components through the local port over the first and second pairs of the plurality of twisted pair conductors, and
the remote USB circuitry recovers the USB information from the positive and negative voltage common mode USB signal components received through the remote port on the first and second pairs of the plurality of twisted pair conductors, and communicates the USB information to one of the plurality of remote USB devices.

8. The HDMI extender of claim 7, wherein when transmitting USB information from one of the plurality of remote USB devices to the local USB device,
the remote USB circuitry converts the USB information into the differential common mode USB signals comprising the positive and negative voltage common mode USB signal components, overlays the positive voltage common mode USB signal component onto the first pair of the plurality of twisted pair conductors, overlays the negative voltage common mode USB signal component onto the second pair of the plurality of twisted pair conductors, and transmits the positive and negative voltage common mode USB signal components through the remote port over the first and second pairs of the plurality of twisted pair conductors, and
the local USB circuitry recovers the USB information from the positive and negative voltage common mode USB signal components received through the local port on the first and second pairs of the plurality of twisted pair conductors, and communicates the USB information to the local USB device.

9. The HDMI extender of claim 8, wherein the secondary microcontroller is coupled to the local USB circuitry through the primary microcontroller, and
wherein the local USB device communicates with a first remote USB device of the plurality of remote USB devices through the primary microcontroller, and the local USB device communicates with a second remote USB device of the plurality of remote USB devices through the secondary microcontroller and the primary microcontroller.

10. The HDMI extender of claim 9, wherein the first USB device is one of a USB touch screen monitor, a USB CAC card reader and a USB whiteboard; and the second USB device is a USB keyboard or mouse.

11. An HDMI extender for extending high definition (HD) multimedia signals from a HD video source to a display device over a single twisted pair cable having a plurality of twisted pair conductors, the HDMI extender comprising:
a local unit comprising:
a video input port receiving local HD multimedia signals from the HD video source, the local HD multimedia signals including a plurality of video signals and at least one control signal;
a local port coupled to a first end of the twisted pair cable;
local circuitry coupled to the video input port and to the local port, the local circuitry converting the local HD multimedia signals into a plurality of differential multimedia signals based on HDBaseT technology for communication through the local port over the twisted pair cable;
a digital audio input for receiving a digital audio signal;
a stereo audio input for receiving an analog audio input;
a local audio codec coupled to the digital and stereo audio inputs, the local audio codec generating an audio output signal based on one of the digital and analog audio inputs;
local audio circuitry coupled to the local audio codec, the local audio circuitry converting the audio output signal into audio differential common mode signals for communication through the local port over the twisted pair cable;
a remote unit separate from the local unit, the remote unit comprising:
a remote port coupled to a second end of the twisted pair cable, the remote port receiving the plurality of differential multimedia signals and the audio differential common mode signals communicated from the local unit over the twisted pair cable;
remote video circuitry coupled to the remote port, the remote video circuitry converting the plurality of differential multimedia signals based on HDBaseT technology into remote HD multimedia signals;
a remote video port coupled to the remote video circuitry, the remote video port providing the remote HD multimedia signals to the display device;
remote audio circuitry coupled to the remote port, the remote audio circuitry recovering the audio output signal from the audio differential common mode signals;
a digital audio output;
a stereo audio output; and
a remote audio codec coupled to the remote audio circuitry and to the digital and stereo audio outputs, the remote audio codec converting the audio output signal into one of a digital audio output signal for output through the digital audio output, and an analog audio output signal for output through the stereo audio output.

12. The HDMI extender of claim 11, wherein the audio differential common mode signals are communicated over two pair of the plurality of twisted pair conductors of the twisted pair cable.

13. The HDMI extender of claim 12, wherein
the local audio circuitry converts the audio output signal into the audio differential common mode signals comprising a positive voltage common mode audio signal component and a negative voltage common mode audio signal component, overlays the positive voltage common mode audio signal component onto a third differential multimedia signal of the plurality of differential multimedia signals on a third pair of the plurality of twisted pair conductors, overlays the negative voltage common mode audio signal component onto a fourth differential multimedia signal of the plurality of differential multimedia signals on a fourth pair of the plurality of twisted pair conductors, and transmits the positive and negative voltage common mode audio signal components through the local port over the third and fourth pairs of the plurality of twisted pair conductors, and
the remote audio circuitry recovers the audio output signal from the positive and negative voltage common mode audio signal components received through the remote port on the third and fourth pairs of the plurality of twisted pair conductors, and communicates the audio output signal to one of the digital and stereo audio outputs.

14. The HDMI extender of claim 13, wherein the digital audio input receives an SPDIF audio signal and the digital audio output outputs the SPDIF audio signal; and when the local audio codec senses the SPDIF audio signal, the local audio codec generates the audio output signal including a PLL lock signal based on the SPDIF audio signal; the remote audio circuitry recovers the audio output signal, and the remote audio codec outputs the SPDIF audio signal based on the audio output signal for output through the digital audio output.

15. An HDMI extender for extending high definition (HD) multimedia signals from a HD video source to a display device over a single twisted pair cable having a plurality of twisted pair conductors, the HDMI extender comprising:
a local unit comprising:
a video input port for receiving local HD multimedia signals from the HD video source, the local HD multimedia signals including a plurality of video signals and at least one control signal;
a local port coupled to a first end of the twisted pair cable;
local circuitry coupled to the video input port and to the local port, the local circuitry converting the local HD multimedia signals into a plurality of differential multimedia signals based on HDBaseT technology for communication through the local port over the twisted pair cable and for extracting a modulated signal preserving an IR carrier frequency received through the local port over the twisted pair cable;
an IR driver coupled to the local circuitry, the IR driver receiving the modulated signal preserving the IR carrier frequency and generating IR commands based on the modulated signal; and
an IR output port coupled to the IR driver, the IR output port providing the IR commands to an IR transmitter for communicating to the HD video source;
a remote unit separate from the local unit, the remote unit comprising:
a remote port coupled to a second end of the twisted pair cable, the remote port receiving the plurality of differential multimedia signals communicated from the local unit over the twisted pair cable;
an IR input port for receiving IR commands from an IR receiver;
remote IR circuitry coupled to the IR input port, the remote IR circuitry generating the modulated signal preserving the IR carrier frequency of the received IR commands;
remote video circuitry coupled to the remote IR circuitry and to the remote port, the remote video circuitry converting the plurality of differential multimedia signals based on HDBaseT technology into remote HD multimedia signals and transmitting the modulated signal preserving the IR carrier frequency from the remote unit through the remote port over the twisted pair cable;
a remote video port coupled to the remote video circuitry, the remote video port providing the remote HD multimedia signals to the display device.

16. The HDMI extender of claim 15, wherein the remote IR circuitry comprises an IR carrier reshaping circuit that generates a pulse each carrier cycle, measures cycle duration, and changes polarity of the modulated signal at half the measured cycle duration.

17. An HDMI extender for extending high definition (HD) multimedia signals from a HD video source to a display device over a single twisted pair cable having a plurality of twisted pair conductors, the HDMI extender comprising:
a local unit comprising:
a video input port for receiving local HD multimedia signals from the HD video source, the local HD multimedia signals including a plurality of video signals and at least one control signal;
a local port coupled to a first end of the twisted pair cable;
local circuitry converting the HD multimedia signals into a plurality of differential multimedia signals based on HDBaseT technology for communication through the local port over the twisted pair cable and for sharing power over the twisted pair cable as a common mode power signal;
a remote unit separate from the local unit, the remote unit comprising:
a remote port coupled to a second end of the twisted pair cable, the remote port receiving the plurality of differential multimedia signals output from the local unit;
remote circuitry coupled to the remote port, the remote circuitry converting the plurality of differential multimedia signals based on HDBaseT technology into remote HD multimedia signals and for sharing the power over the twisted pair cable as the common mode power signal;
a remote video port coupled to the remote circuitry, the remote video port providing the remote HD multimedia signals to the display device.

18. The HDMI extender of claim 17, wherein the power is shared between the local unit the remote unit over the twisted pair cable using a DC voltage signal having a positive terminal and a ground terminal, the positive terminal being coupled to two pairs of the plurality of twisted pair conductors, and the ground terminal being coupled to a different two pairs of the plurality of twisted pair conductors.

19. The HDMI extender of claim 18, wherein the DC voltage signal is 24 V.

20. The HDMI extender of claim 18, wherein the power source providing the power is coupled to one of the local unit and the remote unit, and the power source supplies power to both the local unit and the remote unit.
